(19) United States
(12) Patent Application Publication
(10) Pub. No.: US 2020/0306588 A1
(43) Pub. Date: Oct. 1, 2020

(54) Process and system to locate and connect to a fitness partner

(71) Applicant: Lou Woelfle, Los Angelis, OH (US)

(72) Inventor: Lou Woelfle, Los Angelis, OH (US)

(21) Appl. No.: 16/362,696

(22) Filed: Mar. 25, 2019

(51) Int. Cl. A63B 24/00; G06F 3/0483; G06F 3/0482; G06F 9/54; G06Q 50/00

(52) U.S. Cl. CPC A63B 24/0075; A63B 24/0062; G06F 3/0483; A63B 2024/0065; G06F 9/542; G06Q 50/01; A63B 2024/0081; G06F 3/0482

(57) ABSTRACT

A system and computer application that will allow a user to find a workout partner and to track a user's exercises and progress, while seeing that of others. It would allow a user to put in a profile and list interests as well as their workout plan. The system would work like a smartphone application.

### CROSS-REFERENCES TO RELATED APPLICATIONS (IF ANY)

None

### BACKGROUND

### 1. Field of the Invention

The present invention relates to a process and application to locate and connect with a workout partner and more particular one that has the similar interests.

### 2. Description of Prior Art

68% of Americans are overweight and 45% are single and looking for companionship. Working out together increases the odds of success. But it can be difficult to find someone to align with. People want to lose weight in a safe environment with encouragement, professional advice and opinions. Because the hardest thing about losing weight is finding the motivation.

There is still room for improvement in the art.

### SUMMARY OF THE INVENTION

The current invention is an computer application (app) that can connect users with partners for fitness training. The application tracks exercises and progress, while also letting a user see the progress of others. A user registers, enters their location and fitness goals, as well as their preferences in a work out partner. A user can start losing weight in good company while sharing results on their profile. The system tracks a user's interests and work out style and matches partners based on those interests.

The system, in the preferred embodiment, would work like a smartphone application, this product would be available through the respective marketplace for smartphones.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a sample home page;

FIG. 4 shows a sample settings screen;

FIG. 5 shows a near me map;

FIG. 6 shows potential workout matches;

FIG. 7 shows a sample profile screen;

FIG. 8 shows a workouts screen;

FIG. 9 shows a daily exercise log;

FIG. 10 shows a daily food log;

FIG. 11 shows a sample interests screen;

FIG. 12 shows a notifications screen;

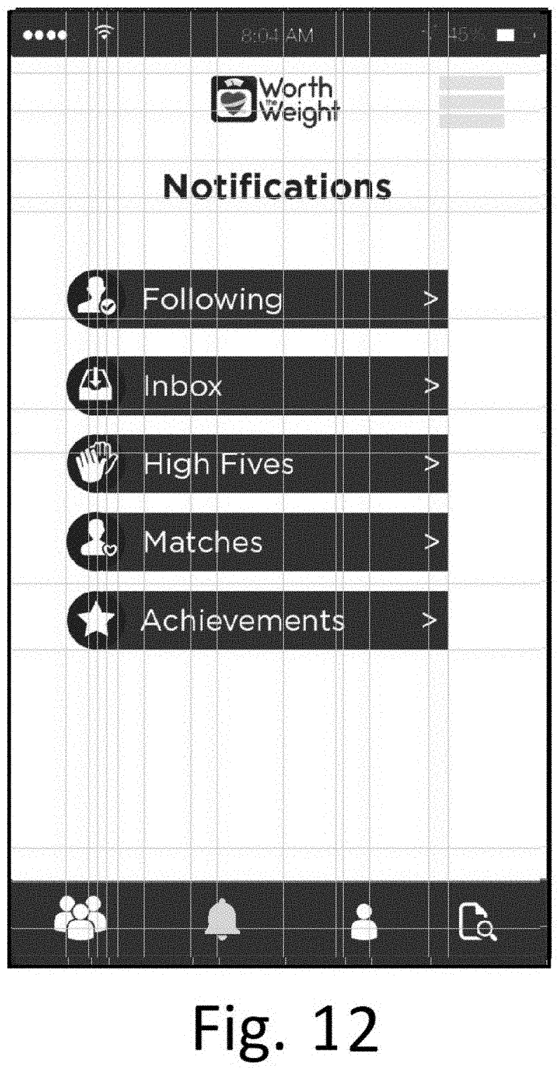

FIG. 13 shows a browse by screen; and

FIG. 14 shows a block diagram of the system and application.

### DESCRIPTION OF THE PREFERRED EMBODIMENT

There are a number of significant design features and improvements incorporated within the invention.

The current invention is a system 1 and application that allows a user to locate and connect with a workout partner. The application 1 tracks exercises and progress, while also letting a user see the progress of others. A user registers, enters their location and fitness goals, as well as their preferences in a work out partner. A user can start losing weight in good company while sharing results on their profile. It tracks a user's interests and work out style and matches partners based on those interests.

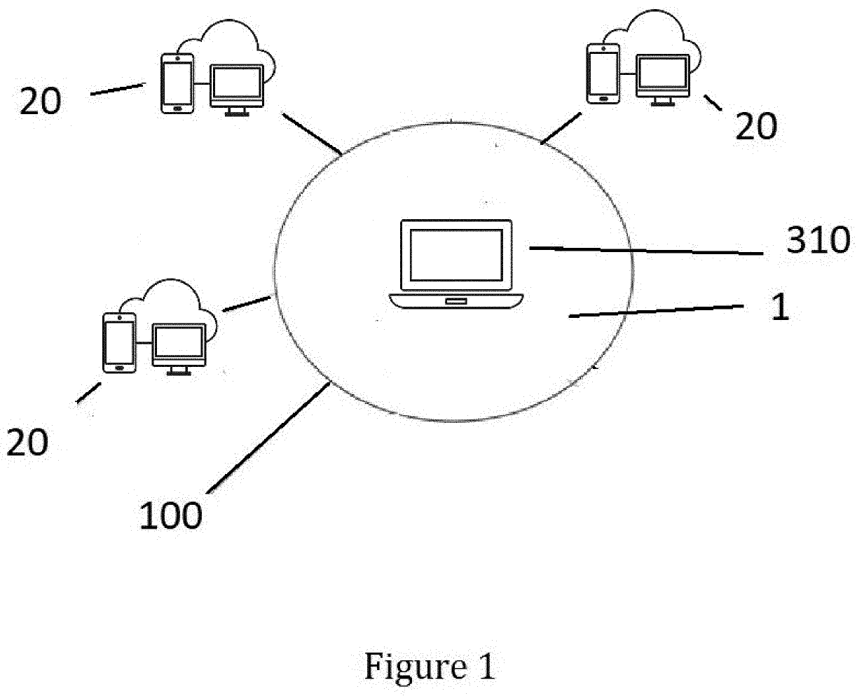

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 20 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 20 or smartphone communicating with others within the system 1.

The system 1, data and processing code can reside in the non-transitory memory 310 of the one or more computing devices. The system 1 in the preferred embodiment would be written to act like a smart phone application (app).

### Brief Overview

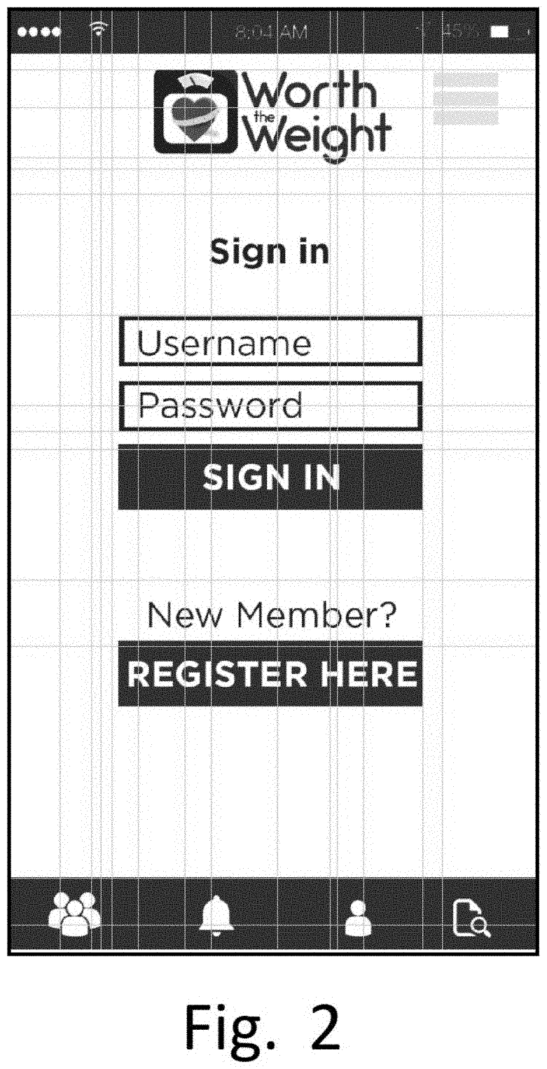

To use the system 1, users would sign-in directly or using social logins as shown in FIG. 2 with the user registering the app,

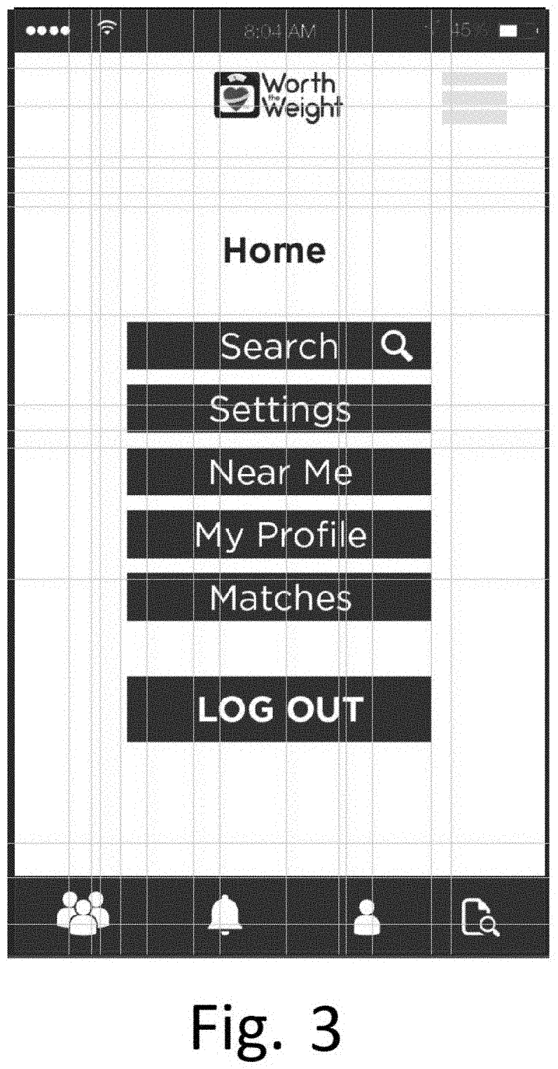

The system 1 will have a home page as shown in FIG. 3. The home page will connect the user to the functions and options of the system such as search, settings, near me, my profile, matches and logout.

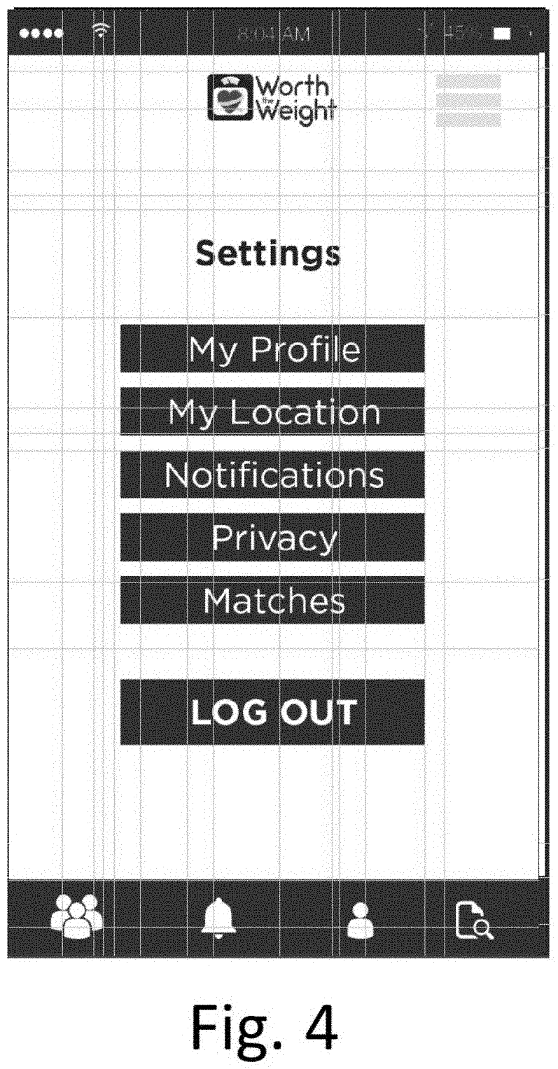

The system 1 has a setting screen which allows a user to set up the system 1 to which set up their settings such as my profile, my location, notifications, privacy, matches and logout as shown in FIG. 4. Other settings can be used with the system 1.

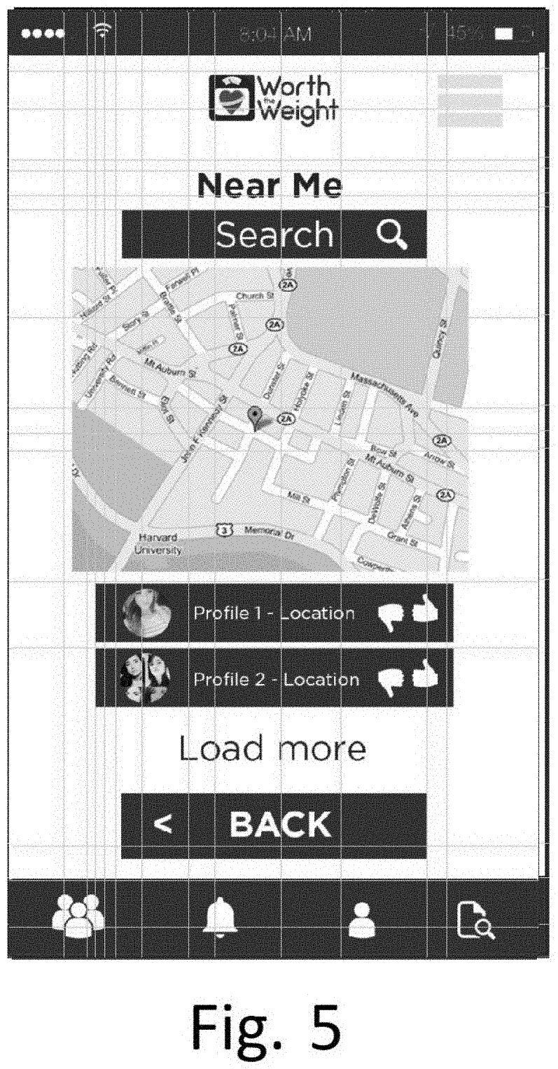

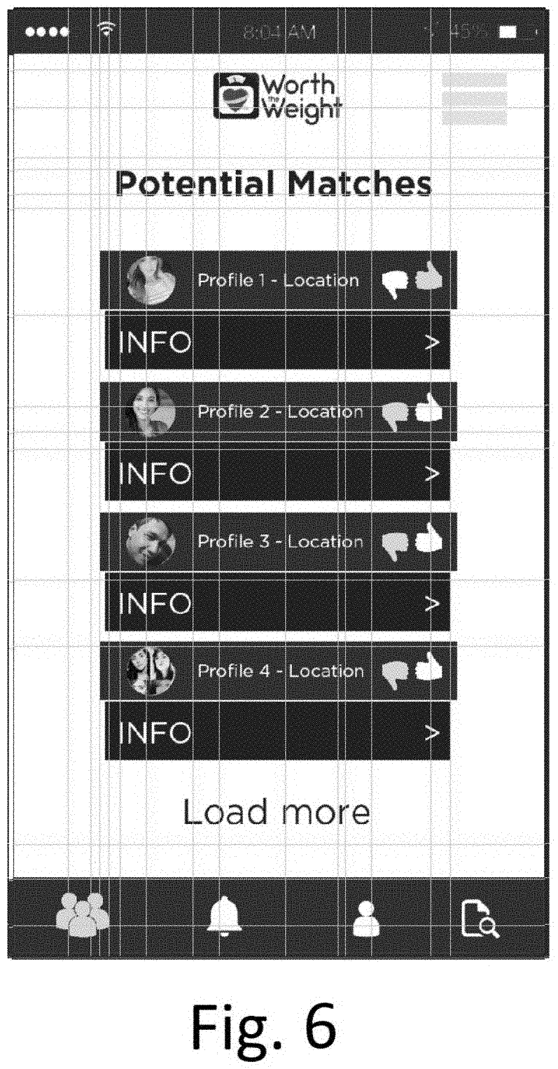

The system 1 will have a near me function which will have a map and allow a user to search for local training partners based on their location and profile as shown in FIG. 5. The system 1 will show potential matches while showing their profiles and locations as shown in FIG. 6. The system 1 will allow the user to load more profiles if the user does not see one that the want to be matched with.

The system 1 will have a categories page as shown in FIG. 6. The categories can be transactions, account, taxes, reports and category.

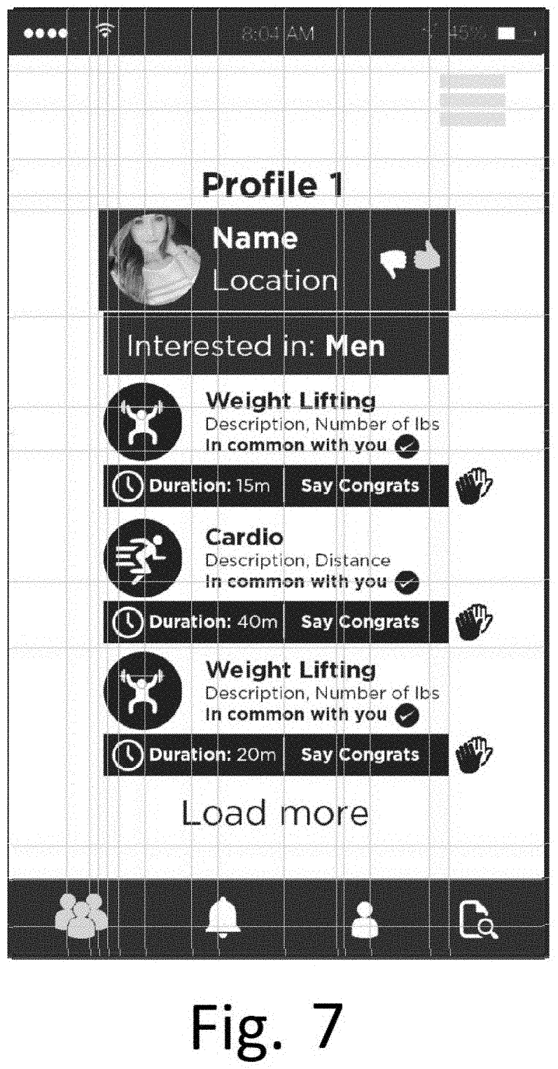

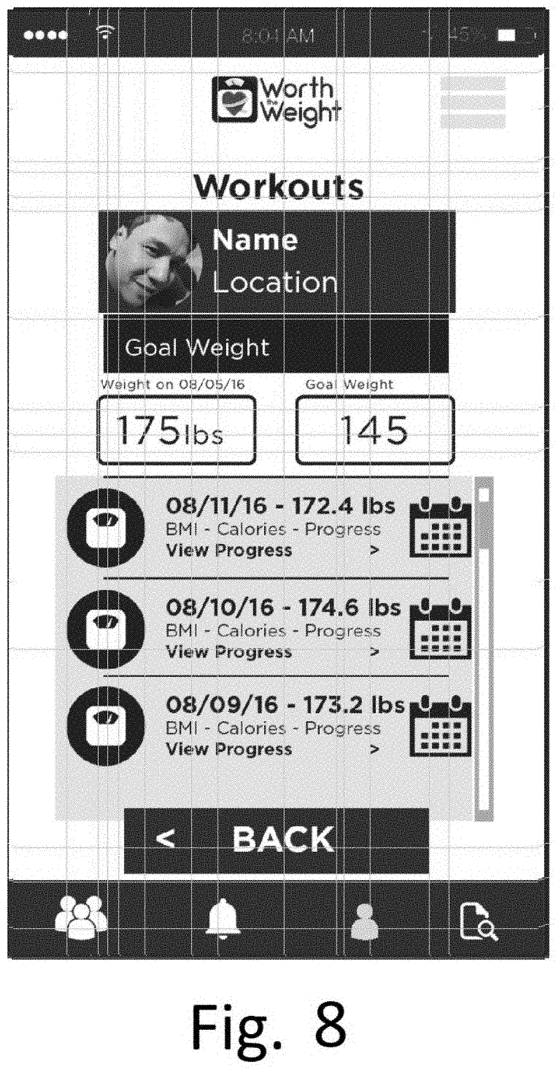

FIG. 7 shows a sample profile screen. The user will set whether they are interested in working out with men or women and the type of workout that they want or interested in such as weight lifting or cardio work out as well as the duration of the workout. The system 1 will give details like goal weights and about a user's workouts as shown in FIG. 8.

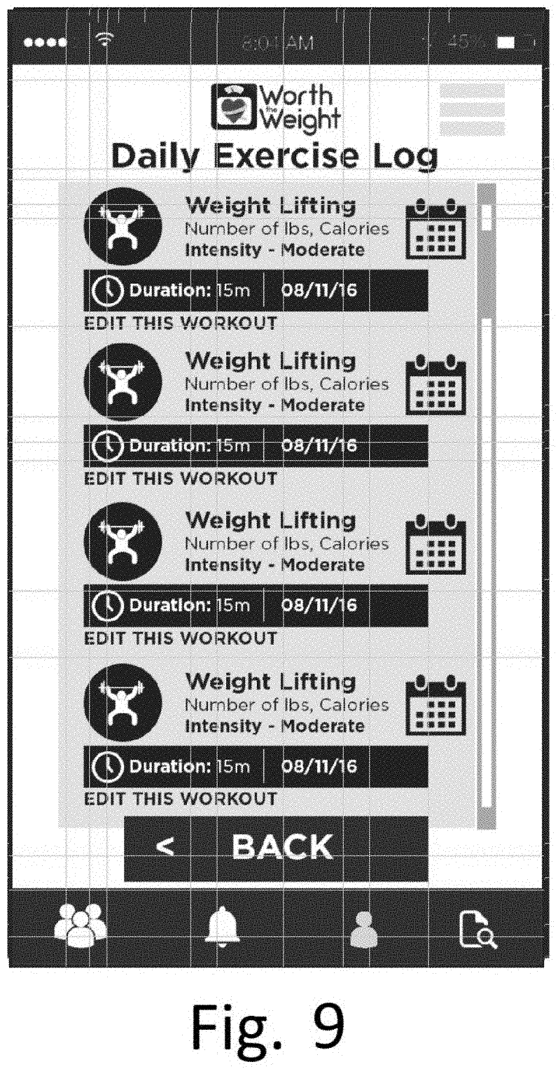

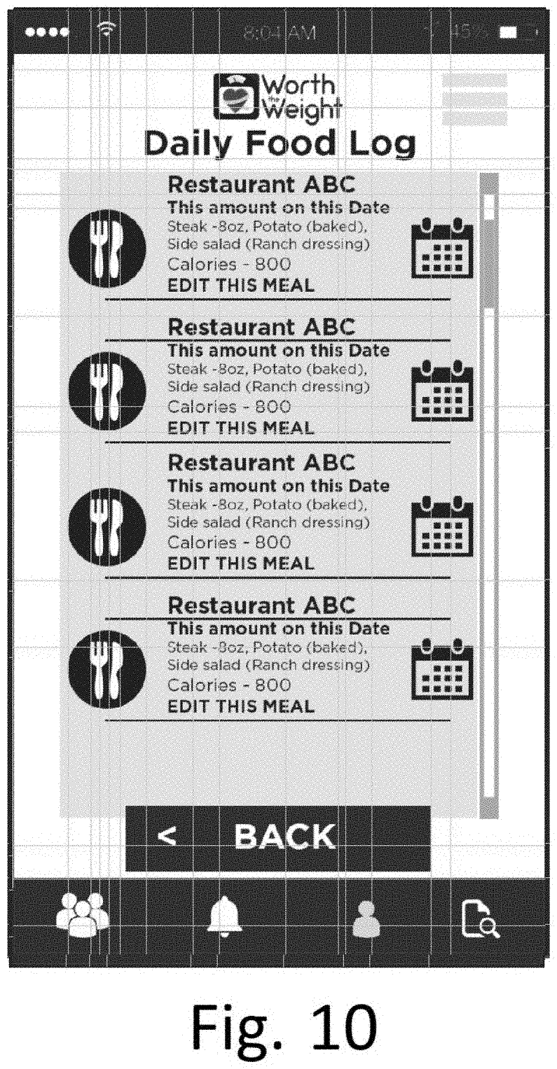

The system 1 keeps track of the user's exercise with a daily exercise log as shown in FIG. 9 where it lists the exercise that a user performed that day. The system 1 will also keep track of the user's food intake as part of the fitness components with a daily food log as shown in FIG. 10.

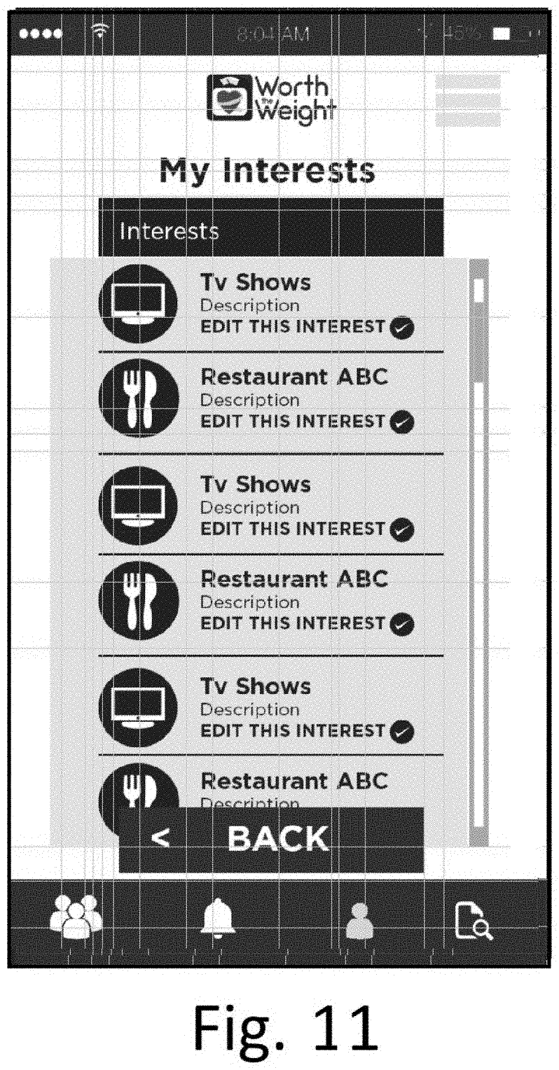

To ensure proper matches, in the preferred embodiment the system will have to user enter their interest such as television shows and restaurants as shown in FIG. 11.

The system 1 has a notification function where the system 1 will notify the user based on select criteria and events such as inbox, matches and achievements. The system 1 will also have a high five function where other users can high five another user is sending praise for something the user had done.

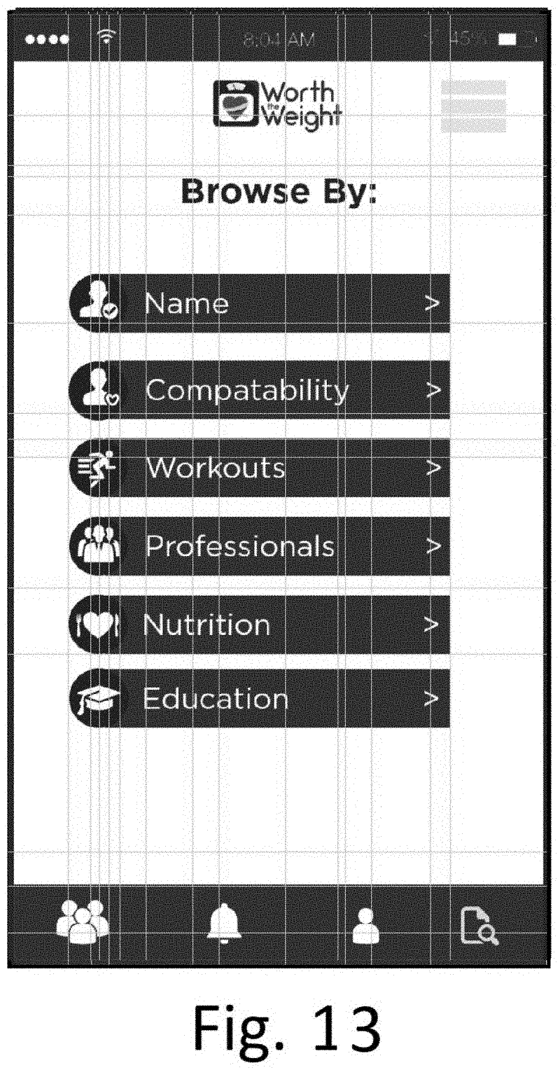

As shown in FIG. 13, the system 1 has a browse function that will allow the user to browse the system by a set criteria such as name, compatibility, workouts, whether the person is a professional or not, nutrition and education.

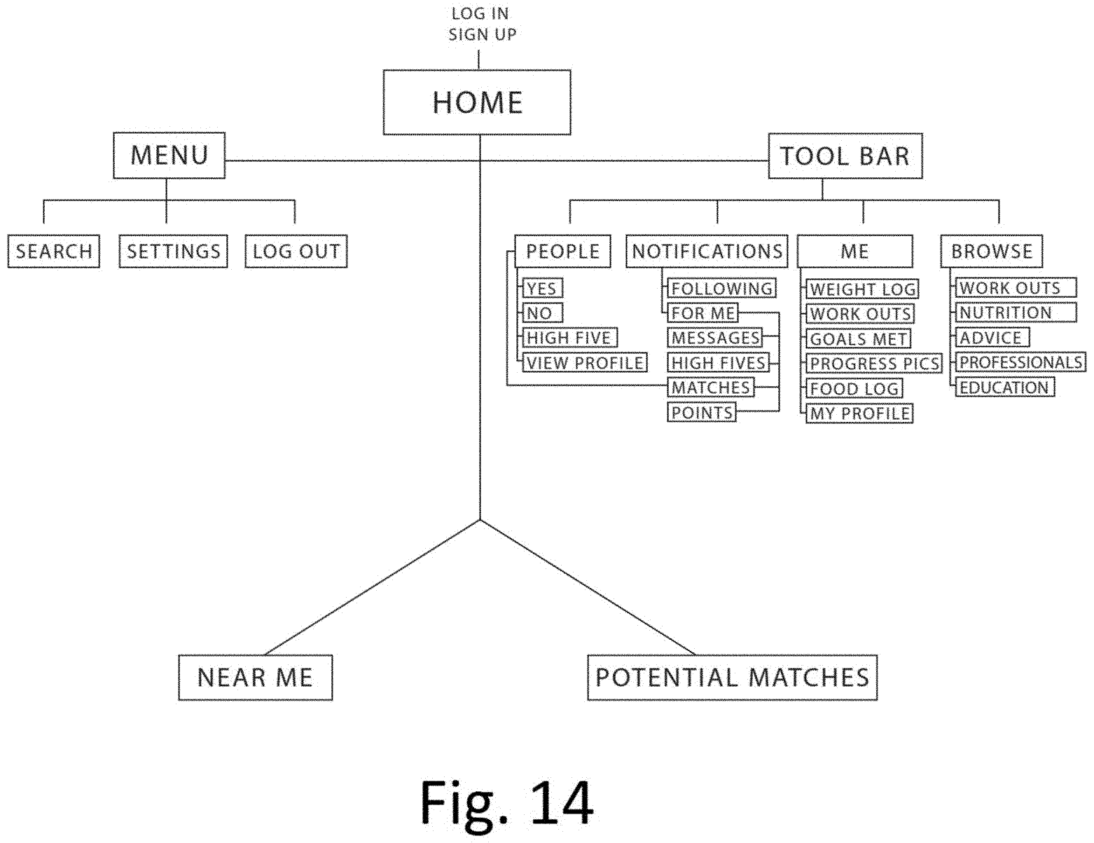

FIG. 14 shows the flow chart of the system 1. The user will Login or Register and Login. The system 1 would bring up the home screen.

### Advantages

The current invention has a progress tracker that updates results every day on a user's profile. It allows a user to enter their location and find potential partners nearby. It has compatibility options and is effective and fun to use allowing for a better workout.

### Conclusion

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system for fitness comprising;
having a system that resides in the non-transitory memory of a computing device;
entering a profile with information;
matching with another profile based on said information and where the other profile is within a certain distance; and
producing reports based on the receipts.

2. A system according to claim 1 having a home screen.

3. A system according to claim 1 having a login screen.

4. A system according to claim 1 where the information involve workout information.

5. A system according to claim 1 having a setting screen with one or more options from a set of my profile, my location, notifications, privacy, matches or logout.

6. A system according to claim 1 where the certain distance can be set.

7. A system according to claim 1 where a user will set whether the user is interested in working out with men or women,

8. A system according to claim 1 where a user will set the type of workout that the user wants.

9. A system according to claim 1 where the information includes goal weights and workouts.

10. A system according to claim 1 where the information includes a daily exercise log.

11. A system according to claim 1 where the information includes lists of the exercises performed that day.

12. A system according to claim 1 where the information includes lists of the exercises performed that day.

13. A system according to claim 1 where the information includes food intake.

14. A system according to claim 1 where the information includes interests.

15. A system according to claim 1 having a notification function.

16. A system according to claim 1 having a high five function.

17. A system according to claim 1 having a browse function.
